(19) United States
(12) Patent Application Publication
(10) Pub. No.: US 2013/0329829 A1
(43) Pub. Date: Dec. 12, 2013

(54) WIRELESS CONTROL APPARATUS, WIRELESS COMMUNICATION SYSTEM, CONTROL PROGRAM, AND INTEGRATED CIRCUIT

(71) Applicants: Kazunari Yokomakura, Osaka-shi (JP); Yasuhiro Hamaguchi, Osaka-shi (JP); Osamu Nakamura, Osaka-shi (JP); Jungo Goto, Osaka-shi (JP); Hiroki Takahashi, Osaka-shi (JP)

(72) Inventors: Kazunari Yokomakura, Osaka-shi (JP); Yasuhiro Hamaguchi, Osaka-shi (JP); Osamu Nakamura, Osaka-shi (JP); Jungo Goto, Osaka-shi (JP); Hiroki Takahashi, Osaka-shi (JP)

(73) Assignee: SHARP KABUSHIKI KAISHA, Osaka-shi, Osaka (JP)

(21) Appl. No.: 14/000,972

(22) PCT Filed: Jan. 30, 2012
(86) PCT No.: PCT/JP2012/052025

§ 371 Date: Aug. 22, 2013

(30) Foreign Application Priority Data
Feb. 23, 2011 (JP) 2011-036824

(51) Int. Cl. H04W 24/02

(52) U.S. Cl. CPC H04W 24/02
USPC 375/285

(57) ABSTRACT

In a transmission method using spectrum shaping, interference to other cells caused by an increase in transmit power of mobile station apparatuses is suppressed. A wireless control apparatus performs control in which at least one wireless terminal apparatus clips part of frequencies in a system band and locates a transmit signal. The wireless control apparatus determines frequencies at which the individual wireless terminal apparatuses locate transmit signals, so that an interference level of the entire system band is suppressed to be lower than or equal to a certain value. Also, the wireless control apparatus determines frequencies at which the individual wireless terminal apparatuses locate transmit signals, so that a total sum of frequency bands allocated to the wireless terminal apparatuses before clipping is smaller than or equal to the system band.

### TECHNICAL FIELD

The present invention relates to a wireless communication system.

### BACKGROUND ART

The standardization of the LTE (Long Term Evolution) system, which is the 3.9th generation wireless communication system for mobile phones, has been substantially completed. Recently, the standardization of LTE-A (LTE-Advanced), which is a development of the LTE system, has been progressing as the 4th generation wireless communication system (also referred to as IMT-A or the like).

Generally, in uplink of a mobile communication system (communication from a mobile station apparatus to a base station apparatus), a mobile station apparatus serves as a transmitter, and thus a single carrier scheme is considered to be effective in which power usage efficiency of an amplifier can be kept high with limited transmit power and peak power is low (in LTE, an SC-FDMA (Single Carrier Frequency Division Multiple Access) scheme is adopted). SC-FDMA is also referred to as DFT-S-OFDM (Discrete Fourier Transform Spread Orthogonal Frequency Division Multiplexing) or DFT-precoded OFDM.

In LTE-A, to further enhance frequency usage efficiency, it has been determined to newly support an access scheme which is referred to as Clustered DFT-S-OFDM (also referred to as DSC (Dynamic Spectrum Control), SC-ASA (Single Carrier Adaptive Spectrum Allocation), or the like), in which an SC-FDMA spectrum is divided into clusters constituted by a plurality of sub-carriers, and the individual clusters are allocated to certain frequencies along a frequency axis, for a mobile station apparatus having sufficient transmit power.

On the other hand, there is disclosed a technology of shaping a frequency signal (spectrum) on the basis of the water filling theorem under the assumption that turbo equalization is used for reception processing (for example, PTL 1). A method disclosed in PTL 1 is a method for maximizing receive power by grasping in advance, in a transmitting apparatus, channel characteristics that affect a signal, and then redistributing the power of individual discrete spectra (sub-carriers) by the transmitting apparatus under the condition that the total transmit power is constant.

In such a transmission method using spectrum shaping, the transmit power of individual discrete spectra (sub-carriers) is determined so that the power of receive signals becomes high under the condition that the total transmit power is constant with respect to transmit signals in the frequency domain of individual mobile station apparatuses. Thus, if turbo equalization operates appropriately, the final transmission characteristics are determined by receive energy, and thus transmission performance is maximized.

Furthermore, focusing attention on that the water filling theorem provides a process of clipping part of a frequency signal, a method for multiplexing a signal of another mobile station apparatus on a clipped frequency has been suggested (for example, NPL 1).

### CITATION LIST

### Patent Literature

PTL 1: Japanese Unexamined Patent Application Publication No. 2008-219144

### Non Patent Literature

NPL 1: A. Okada, et. al., “Spectrum Shaping Technique Combined with SC/MMSE Turbo Equalizer for High Spectral Efficient Broadband Wireless Access Systems”, ICSPCS2007, Gold Coast, Australia, December 2007.

### SUMMARY OF INVENTION

### Technical Problem

In uplink communication, when individual mobile station apparatuses transmit data, transmit power control (TPC) is applied so that a base station apparatus can receive the data at a certain reception level. The transmit power control also plays a role of adjusting the amount of an interference level with respect to an adjacent cell, and the level of interference waves is controlled as IoT (Interference over Thermal noise). Therefore, if the method according to NPL 1 is adopted as is, the total transmit power of all mobile station apparatuses in the same bandwidth becomes high, transmit power control among cells causes mutual increase in transmit power, and accordingly the system falls into an unstable condition.

The present invention has been made in view of these circumstances, and an object of the invention is to provide a wireless control apparatus, a wireless communication system, a control program, and an integrated circuit that are capable of suppressing interference to other cells caused by an increase in transmit power of mobile station apparatuses, in a transmission method using spectrum shaping.

### Solution to Problem

(1) To achieve the above-described object, the present invention takes the following measures. That is, a wireless control apparatus according to the present invention is a wireless control apparatus that performs control in which at least one wireless terminal apparatus clips part of frequencies in a system band and locates a transmit signal. The wireless control apparatus determines frequencies at which the individual wireless terminal apparatuses locate transmit signals, so that an interference level of the entire system band is suppressed to be lower than or equal to a certain value.

In this way, the wireless control apparatus determines frequencies at which the individual wireless terminal apparatuses locate transmit signals, so that an interference level of the entire system band is suppressed to be lower than or equal to a certain value. Accordingly, the system can be stabilized.

(2) Further, the wireless control apparatus according to the present invention determines frequencies at which the individual wireless terminal apparatuses locate transmit signals, so that a total sum of frequency bands allocated to the wireless terminal apparatuses before clipping is smaller than or equal to the system band.

In this way, the wireless control apparatus determines frequencies at which the individual wireless terminal apparatuses locate transmit signals, so that a total sum of frequency bands allocated to the wireless terminal apparatuses before clipping is smaller than or equal to the system band. Thus, when frequency allocation is determined, control can be performed to suppress variations of an interference level caused by a large first number of RBs, which is the number of RBs before clipping. Accordingly, the system is stabilized.

(3) Further, the wireless control apparatus according to the present invention calculates a target receive power value in the wireless control apparatus by using a receive power value with which the interference level of the entire system band is lower than or equal to the certain value, a total sum of frequency bands allocated to the wireless terminal apparatuses before clipping, and a clipping ratio of frequencies at which transmit signals are located in the system band, and determines transmit power of the wireless terminal apparatuses on the basis of the target receive power value.

In this way, the wireless control apparatus calculates a target receive power value in the wireless control apparatus by using a receive power value with which the interference level of the entire system band is lower than or equal to the certain value, a total sum of frequency bands allocated to the wireless terminal apparatuses before clipping, and a clipping ratio of frequencies at which transmit signals are located in the system band. Accordingly, the system to which clipping (or spectrum shaping) is applied can be stabilized.

(4) Further, the wireless control apparatus according to the present invention determines transmit power of the wireless terminal apparatuses on the basis of the target receive power value and a parameter specific to a cell controlled by the wireless control apparatus.

In this way, the wireless control apparatus determines transmit power of the wireless terminal apparatuses on the basis of the target receive power value and a parameter specific to a cell controlled by the wireless control apparatus. Accordingly, the system can be stabilized.

(5) Further, in a case where a total sum of frequency bands allocated to the wireless terminal apparatuses before clipping exceeds the system band, the wireless control apparatus according to the present invention determines transmit power of the wireless terminal apparatuses by subtracting transmit power corresponding to a frequency band as an excess.

In this way, in a case where a total sum of frequency bands allocated to the wireless terminal apparatuses before clipping exceeds the system band, the wireless control apparatus determines transmit power of the wireless terminal apparatuses by subtracting transmit power corresponding to a frequency band as an excess. Accordingly, the system to which clipping (or spectrum shaping) is applied can be stabilized.

(6) Further, in the wireless control apparatus according to the present invention, the interference level is represented by IoT (Interference over Thermal noise power ratio).

In this way, the interference level is represented by IoT (Interference over Thermal noise power ratio). Accordingly, the wireless terminal apparatuses can adjust the amount of an interference level with respect to an adjacent cell by performing transmit power control.

(7) Further, in the wireless control apparatus according to the present invention, the IoT is determined by a parameter of transmit power control performed by the wireless terminal apparatuses.

In this way, the IoT is determined by a parameter of transmit power control performed by the wireless terminal apparatuses. Accordingly, the wireless terminal apparatuses can adjust the amount of an interference level with respect to an adjacent cell by performing transmit power control.

(8) Further, in the wireless control apparatus according to the present invention, the transmit power control is fractional transmit power control.

In this way, the transmit power control is fractional transmit power control. Accordingly, the wireless control apparatus can keep the amount of interference to an adjacent cell (IoT measured by the wireless control apparatus in an adjacent cell) constant without degrading reception quality of the wireless terminal apparatus near the wireless control apparatus.

(9) Further, a wireless communication system according to the present invention includes the wireless control apparatus according to any of the above (1) to (8), and a plurality of wireless terminal apparatuses.

In this way, the wireless communication system includes the wireless control apparatus according to any of the above (1) to (8), and a plurality of wireless terminal apparatuses. Accordingly, the wireless control apparatus can stabilize the system.

(10) Further, a control program according to the present invention is a control program for a wireless control apparatus that performs control in which at least one wireless terminal apparatus clips part of frequencies in a system band and locates a transmit signal. The control program causes a computer to execute a process of determining frequencies at which the individual wireless terminal apparatuses locate transmit signals, so that an interference level of the entire system band is suppressed to be lower than or equal to a certain value.

In this way, the control program determines frequencies at which the individual wireless terminal apparatuses locate transmit signals, so that an interference level of the entire system band is suppressed to be lower than or equal to a certain value. Accordingly, the wireless control apparatus can stabilize the system.

(11) Further, the control program according to the present invention further includes a process of determining frequencies at which the individual wireless terminal apparatuses locate transmit signals, so that a total sum of frequency bands allocated to the wireless terminal apparatuses before clipping is smaller than or equal to the system band.

In this way, the control program determines frequencies at which the individual wireless terminal apparatuses locate transmit signals, so that a total sum of frequency bands allocated to the wireless terminal apparatuses before clipping is smaller than or equal to the system band. Thus, when frequency allocation is determined, the wireless control apparatus can perform control to suppress variations of an interference level caused by a large first number of RBs, which is the number of RBs before clipping. Accordingly, the system is stabilized.

(12) Further, the control program according to the present invention further includes a process of calculating a target receive power value in the wireless control apparatus by using a receive power value with which the interference level of the entire system band is lower than or equal to the certain value, a total sum of frequency bands allocated to the wireless terminal apparatuses before clipping, and a clipping ratio of frequencies at which transmit signals are located in the system band, and a process of determining transmit power of the wireless terminal apparatuses on the basis of the target receive power value.

In this way, the control program calculates a target receive power value in the wireless control apparatus by using a receive power value with which the interference level of the entire system band is lower than or equal to the certain value, a total sum of frequency bands allocated to the wireless terminal apparatuses before clipping, and a clipping ratio of frequencies at which transmit signals are located in the system band. Accordingly, the wireless control apparatus can stabilize the system to which clipping (or spectrum shaping) is applied.

(13) Further, the control program according to the present invention further includes a process of determining transmit power of the wireless terminal apparatuses on the basis of the target receive power value and a parameter specific to a cell controlled by the wireless control apparatus.

In this way, the control program determines transmit power of the wireless terminal apparatuses on the basis of the target receive power value and a parameter specific to a cell controlled by the wireless control apparatus. Accordingly, the wireless control apparatus can stabilize the system.

(14) Further, the control program according to the present invention further includes a process of determining, in a case where a total sum of frequency bands allocated to the wireless terminal apparatuses before clipping exceeds the system band, transmit power of the wireless terminal apparatuses by subtracting transmit power corresponding to a frequency band as an excess.

In this way, the control program determines, in a case where a total sum of frequency bands allocated to the wireless terminal apparatuses before clipping exceeds the system band, transmit power of the wireless terminal apparatuses by subtracting transmit power corresponding to a frequency band as an excess. Accordingly, the wireless control apparatus can stabilize the system to which clipping (or spectrum shaping) is applied.

(15) Further, an integrated circuit according to the present invention is an integrated circuit that is mounted in a wireless control apparatus to cause the wireless control apparatus to implement a plurality of functions. The integrated circuit causes the wireless control apparatus to implement a series of functions including a function of performing control in which at least one wireless terminal apparatus clips part of frequencies in a system band and locates a transmit signal, and a function of determining frequencies at which the individual wireless terminal apparatuses locate transmit signals, so that an interference level of the entire system band is suppressed to be lower than or equal to a certain value.

In this way, the integrated circuit determines frequencies at which the individual wireless terminal apparatuses locate transmit signals, so that an interference level of the entire system band is suppressed to be lower than or equal to a certain value. Accordingly, the wireless control apparatus can stabilize the system.

### Advantageous Effects of Invention

According to the present invention, a wireless communication system to which spectrum shaping is applied is stabilized. That is, as a result of applying the present invention, a base station apparatus performs control to suppress variations of an interference level caused by the number of RBs before clipping that is larger than the number of RBs included in a system frequency band, when frequency allocation is determined. Accordingly, the system can be stabilized.

### BRIEF DESCRIPTION OF DRAWINGS

FIG. 1 is a diagram illustrating a concept of a wireless communication system according to the present invention.

FIG. 2 is a block diagram illustrating the configuration of a mobile station apparatus 1 according to a first embodiment of the present invention.

FIG. 3 is a block diagram illustrating the configuration of a base station apparatus 2 according to the first embodiment of the present invention.

FIG. 4 is a block diagram illustrating the configuration of a scheduling unit 213 according to the first embodiment of the present invention.

FIG. 5A is a diagram illustrating a transmit frequency signal in a first mobile station apparatus 1-1 according to the first embodiment of the present invention.

FIG. 5B is a diagram illustrating a receive frequency signal in a first base station apparatus 2-1 according to the first embodiment of the present invention.

FIG. 6 is a flowchart illustrating the operation of the base station apparatus 2 according to the first embodiment of the present invention.

FIG. 7 is a block diagram illustrating the configuration of a mobile station apparatus 1 according to a second embodiment of the present invention.

FIG. 8 is a block diagram illustrating the configuration of a base station apparatus 2 according to the second embodiment of the present invention.

FIG. 9 is a block diagram illustrating the configuration of a scheduling unit 505 according to the second embodiment of the present invention.

FIG. 10 is a flowchart illustrating the operation of the base station apparatus 2 according to the second embodiment of the present invention.

FIG. 11 is a graph illustrating the relationship between the receive power of the base station apparatus 2 and PL in a case where α is changed in a third embodiment of the present invention.

### DESCRIPTION OF EMBODIMENTS

Hereinafter, embodiments of the present invention will be described with reference to the drawings. A description will be given below under the assumption that the following embodiments are applicable to a method for making total transmit power constant by clipping spectrum shaping, but the embodiments are applicable to any method as long as the method is a method for performing preprocessing on a frequency signal in the frequency domain and includes clipping, such as spectrum shaping based on the water filling theorem. Spectrum shaping corresponds to a clipping technique, which is a process of removing part of a transmit signal in the frequency domain, or a process of redistributing transmit power in the frequency domain.

### First Embodiment

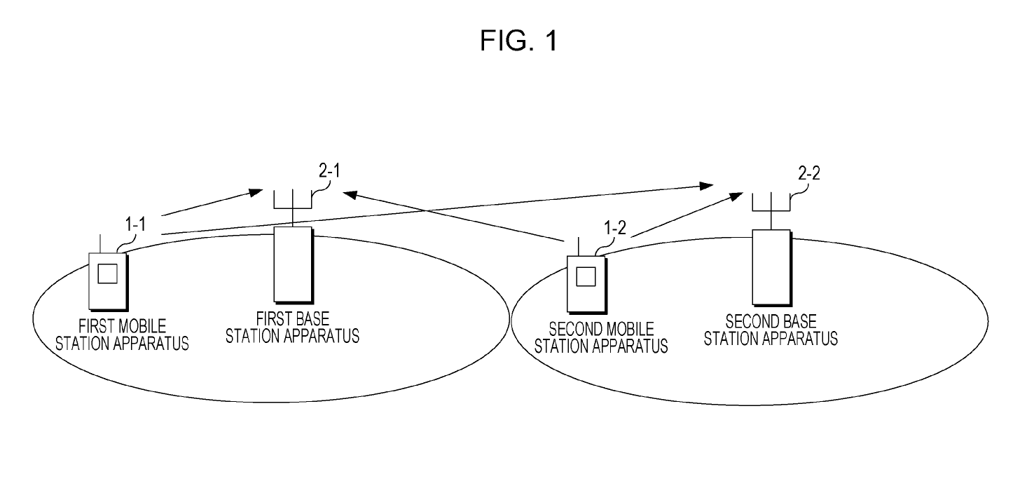

FIG. 1 is a diagram illustrating a concept of a wireless communication system according to the present invention. In FIG. 1, it is assumed that a first base station apparatus 2-1 and a first mobile station apparatus 1-1 are connected, and a second base station apparatus 2-2 and a second mobile station apparatus 1-2 are connected. Hereinafter, the first mobile station apparatus 1-1 and the second mobile station apparatus 1-2 are collectively referred to as mobile station apparatuses 1, and the first base station apparatus 2-1 and the second base station apparatus 2-2 are collectively referred to as base station apparatuses 2. In this case, as illustrated in FIG. 1, the first mobile station apparatus 1-1 is interference to the second base station apparatus 2-2, and is also interference to the first base station apparatus 2-1.

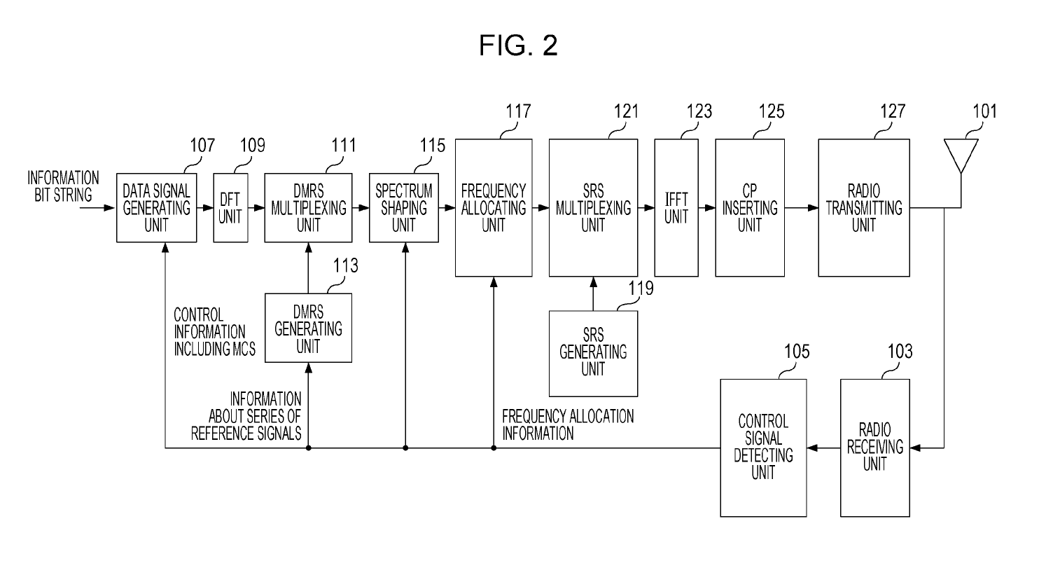

FIG. 2 is a block diagram illustrating the configuration of the mobile station apparatus 1 according to the first embodiment of the present invention. A control signal transmitted from the base station apparatus 2 and received by an antenna 101 is subjected to down conversion and A/D (Analog to Digital) conversion in a radio receiving unit 103, and is then input to a control signal detecting unit 105. The control signal detecting unit 105 detects control information that is necessary for data transmission, including MCS (Modulation and Coding Schemes) indicating information that is necessary for encoding or modulation, such as a modulation scheme, the number of information bits (also defined as a transport block size), or a coding rate; information about retransmission; information indicating a series of demodulation reference signals (including CSI (Cyclic Shift Index) or the like); and frequency allocation information indicating a scheduling result in the base station apparatus 2. The detected control information including MCS is input to a data signal generating unit 107.

The data signal generating unit 107 performs error-correction coding on an information bit string to be transmitted on the basis of the control information input thereto, and then performs modulation such as quaternary phase shift keying (QPSK) or 16-ary quadrature amplitude modulation (16QAM). After that, a modulated time signal which is an output from the data signal generating unit 107 is transformed to a frequency signal by a discrete Fourier transform (DFT) unit 109, and is then input to a demodulation reference signal multiplexing unit 111. On the other hand, in a demodulation reference signal generating unit 113, a demodulation reference signal (DMRS) is generated on the basis of information about a series of reference signals received from the control signal detecting unit 105, and the generated demodulation reference signal is input to the demodulation reference signal multiplexing unit 111 and is time-multiplexed with a data signal. The data signal multiplexed with the DMRS is subjected to clipping on the basis of spectrum shaping information in a spectrum shaping unit 115.

Subsequently, in a frequency allocating unit 117, the data signal to be transmitted on which spectrum shaping has been performed is located in a system band on the basis of frequency allocation information. Further, a sounding reference signal generating unit 119 generates a sounding reference signal (SRS) with which the base station apparatus 2 grasps the state of the entire system band or part of a channel to perform scheduling. The generated sounding reference signal is input to a sounding reference signal multiplexing unit 121, and is multiplexed with the data signal on which frequency allocation has been performed. After that, the frequency signal multiplexed with the sounding reference signal is transformed to a time signal by an inverse fast Fourier transform (IFFT) unit 123. Then, in a cyclic prefix (CP) inserting unit 125, a cyclic prefix (CP) generated by copying a waveform in a backward portion of time to a frontward portion is inserted into the time signal. The time signal is then subjected to D/A (Digital to Analog) conversion and up conversion in a radio transmitting unit 127, and is transmitted from the antenna 101.

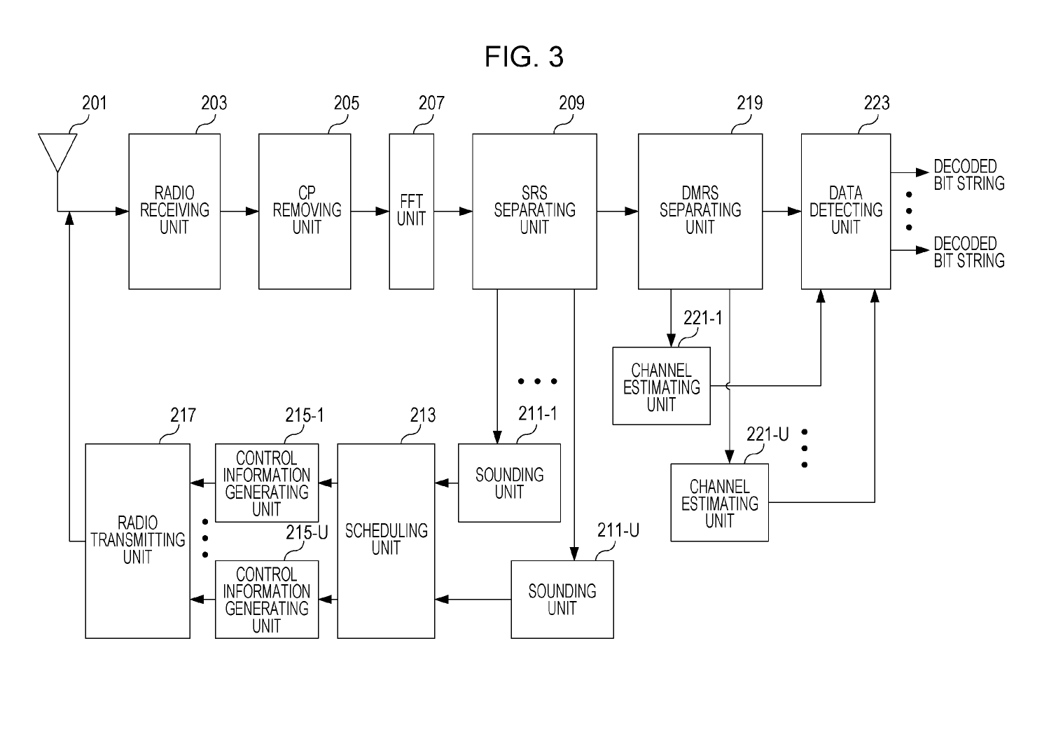

FIG. 3 is a block diagram illustrating the configuration of the base station apparatus 2 according to the first embodiment of the present invention. A receive signal received by an antenna 201 is subjected to down conversion and A/D conversion in a radio receiving unit 203, and a CP is removed therefrom in a CP removing unit 205. The receive signal from which the CP has been removed is transformed to a receive signal in the frequency domain by an FFT unit 207. Subsequently, an SRS is separated from the receive signal in the frequency domain by a sounding reference signal separating unit 209. The separated SRS is input to sounding units 211-1 to 211-U (the sounding units 211-1 to 211-U are collectively referred to as sounding units 211) that grasp the state of a channel of a frequency band in which transmission can be performed. Here, sounding is performed for each mobile station apparatus 1, and thus the number of sounding units 211 is the same as the number of connected mobile station apparatuses U for convenience. However, one block of a sounding unit may be provided in the case of sequentially performing sounding using SRSs from the individual mobile station apparatuses 1.

Obtained sounding results (channel states) from the individual mobile station apparatuses 1 to the base station 2 are input to a scheduling unit 213. The scheduling unit 213 determines frequency allocation and spectrum shaping information for the individual mobile station apparatuses 1, and input them to control information generating units 215-1 to 215-U. At this time, the frequency allocation set by the scheduling unit 213 is determined so as to satisfy expression (1). The control information generating units 215-1 to 215-U generate information that is necessary for communication, other than the received frequency allocation and spectrum shaping information for the individual mobile station apparatuses 1, and converts the generated information to a certain format (a format defined by various wireless communication systems, such as LTE or WiMAX (for example, a downlink control information (DCI) format in LTE)). A radio transmitting unit 217 converts the information to a radio signal, and the antenna 201 transmits the radio signal as control information.

On the other hand, in a demodulation reference signal separating unit 219, a DMRS is separated from the receive signal output from the sounding reference signal separating unit 209. The separated DMRS is input to channel estimating units 221-1 to 221-U. The channel estimating units 221-1 to 221-U estimate, by using the received DMRS, channel characteristics in the frequency used for data transmission. A data detecting unit 223 decodes transmit bits by performing nonlinear iterative equalization or the like by using an input from the demodulation reference signal separating unit 219 in which DMRS has been separated and the channel characteristics estimated by the channel estimating units 221-1 to 221-U, thereby obtaining decoded bit strings for the individual mobile station apparatuses 1.

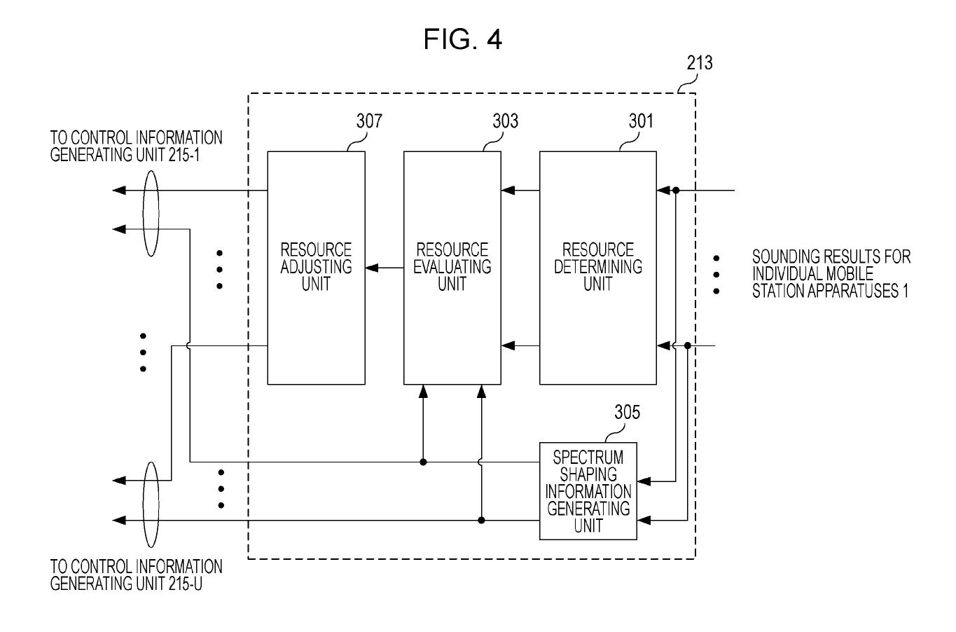

FIG. 4 is a block diagram illustrating the configuration of the scheduling unit 213 according to the first embodiment of the present invention. In the scheduling unit 213, sounding results for the individual mobile station apparatuses 1 received from the sounding units 211-1 to 211-U are input to a resource determining unit 301. The resource determining unit 301 determines the frequency positions of resource blocks used for transmission by the individual mobile station apparatuses 1, and inputs information about the frequency positions to a resource evaluating unit 303. At the same time, a spectrum shaping information generating unit 305 determines the number of RBs to be clipped. Hereinafter, the number of RBs before clipping is defined as the first number of RBs, and the number of RBs used for a frequency signal after clipping is defined as the second number of RBs.

Subsequently, the resource evaluating unit 303 compares, using expression (1), the total sum of the first numbers of RBs allocated by scheduling to all the mobile station apparatuses 1 with the number of RBs included in a system band. For example, the resource evaluating unit 303 calculates an excess of the total sum of the first numbers of RBs, and outputs the information about the excess to a resource adjusting unit 307. In a case where a large number of RBs are allocated, the resource adjusting unit 307 performs adjustment so that the number of RBs to be substantially used becomes smaller than or equal to the number of RBs in the allocated bandwidth.

Hereinafter, for specific description, it is assumed that the number of mobile station apparatuses is 3 and that the number of RBs included in the system band is 10. Also, it is assumed that the second numbers of RBs allocated to the individual mobile station apparatuses 1 by the resource determining unit 301 are (4, 3, 3), respectively. In this case, if the numbers of clipped RBs are (1, 1, 0), the total sum of the first numbers of RBs for all the mobile station apparatuses 1 is 4+3+3+1+1+0=12, including the clipped RBs. When this is compared using expression (1), it is understood that an excess is two RBs. In order to set the total sum of the second numbers of RBs to 10, the number of RBs may be reduced by 2 in total. For example, if the numbers of RBs to be allocated are changed from (4, 3, 3) to (3, 2, 3), the total sum of the first numbers of RBs for all the mobile station apparatuses 1 is 3+2+3+1+1+0=10 in a case where the numbers of clipped RBs are (1, 1, 0), which corresponds to ten RBs included in the system band.

As a result, clipping can be applied without changing average transmit power allocated a unit RB. At this time, any method may be used to reduce the number of RBs. For example, among allocated RBs, RBs for the mobile station apparatus 1 to which RBs of the smallest gain of a channel obtained through sounding are allocated may be reduced. Alternatively, on the basis of the number of RBs allowed to be clipped in each mobile station apparatus 1, RBs allocated to the mobile station apparatus 1 in which the first number of RBs is smaller than the number of RBs allowed to be clipped may be released.

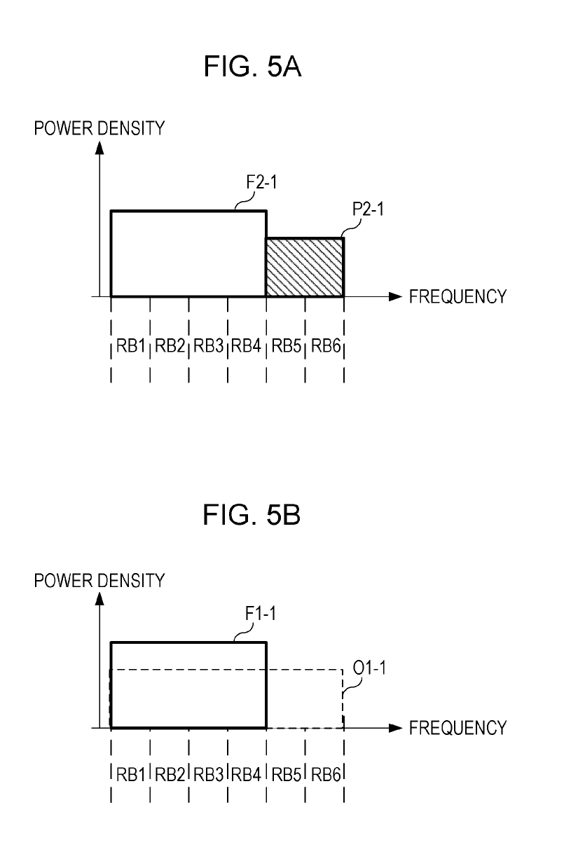

FIG. 5A is a diagram illustrating a transmit frequency signal in the first mobile station apparatus 1-1 according to the first embodiment of the present invention. FIG. 5B is a diagram illustrating a receive frequency signal in the first base station apparatus 2-1 according to the first embodiment of the present invention. The horizontal axis represents the frequency, and the vertical axis represents the power density of the frequency signal. Here, RB1 to RB6 denote resource blocks (RBs), which are the smallest units of frequency resources. In LTE, for example, each RB is constituted by twelve sub-carriers (discrete frequencies, resource elements). The first mobile station apparatus 1-1 transforms a time signal to a frequency signal O1-1 by DFT, performs clipping on the frequency signal O1-1 to remove part of the frequency signal, and generates a frequency signal F1-1 to which the power corresponding to the clipped part of the frequency signal is redistributed.

In this case, the frequency signal O1-1 is supposed to be transmitted by using six RBs RB1 to RB6. However, with the application of clipping, the frequency signal O1-1 is shaped into the frequency signal F1-1, which is transmitted using four RBs RB1 to RB4. At this time, the transmit power of the clipped 5RB and 6RB is redistributed to RB1 to RB4, so that the power density can be set to be high. The signal allocated in this manner is received as a frequency signal F2-1 by the base station apparatus 2. In this case, a frequency signal P2-1 is a receive frequency signal in a case where the frequency saved by clipping is allocated to another mobile station apparatus 1.

Next, interference to an adjacent cell will be discussed. Normally, if there are available radio resources, and if data to be transmitted exists in a buffer, the base station apparatus 2 allocates the radio resources to a certain mobile station apparatus 1 in the scheduling of determining allocation of the radio resources. In the case of FIG. 5B, if there is data in the buffer of the mobile station apparatus 1 that is connected to the first base station apparatus 2-1, RB5 and RB6 are normally allocated for a frequency signal P2-1 to the mobile station apparatus 1.

In this case, however, even if the mobile station apparatus 1 that has transmitted the frequency signal P2-1 does not apply clipping, because the first mobile station apparatus 1-1 redistributes the power corresponding to two RBs, the total transmit power of all the mobile station apparatuses 1 is higher by the amount corresponding to two RBs than in the case of transmitting only the frequency signal O1-1. Thus, RB5 and RB6 in FIG. 5A are not allocated regardless of the buffer, that is, control is performed so that the total transmit power of all the mobile station apparatuses 1 becomes smaller than or equal to the power in the system band, thereby destabilization of the system is prevented.

Generally, when it is assumed that the number of mobile station apparatuses 1 is U and the number of RBs included in the system band is M, control is performed so that the total sum of the numbers of RBs allocated to the individual mobile station apparatuses 1 before clipping (the number of RBs corresponding to the frequency signal O1-1 in FIG. 5A) becomes M or less. That is, control is performed so that expression (1) is satisfied.

$$\begin{matrix}[ Math . 1 ] & \\ M \geq {\sum }_{u = 1}^{U} N ( u ) & ( 1 )\end{matrix}$$

Here, N(u) represents the number of RBs before clipping in the u-th mobile station apparatus 1. Such control stabilizes the system.

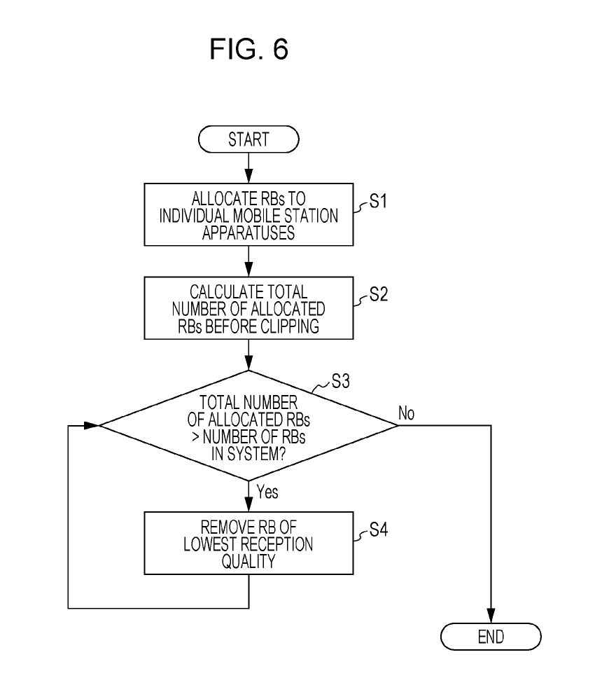

FIG. 6 is a flowchart illustrating the operation of the base station apparatus 2 according to the first embodiment of the present invention. First, the base station apparatus 2 allocates RBs to the individual mobile station apparatuses 1 (step S1). Subsequently, the base station apparatus 2 calculates the total number of allocated RBs before clipping (step S2). At this time, the number of RBs to be clipped may be determined in advance, or may be associated with the MCS or the like, which is estimated from the reception quality of each mobile station apparatus 1, in one-to-one correspondence. The MCS may be determined in accordance with the reception quality of RBs allocated by scheduling. In this case, after determining the MCSs of the individual mobile station apparatuses 1, the first numbers of RBs of the individual mobile station apparatuses 1 may be calculated by using the clipping ratios or the like associated with the MCSs, and the total sum of the first numbers of RBs may be calculated to set the maximum clipping ratio. The procedure of setting the maximum clipping ratio, which is defined as (the first number of RBs—the second number of RBs)/the first number of RBs and which is associated with the MCS in one-to-one correspondence, is described in a second embodiment.

Subsequently, the base station apparatus 2 determines whether or not the total sum of the first numbers of RBs allocated to the individual mobile station apparatuses 1 is larger than the number of RBs in the system (step S3). If the total sum is larger (YES in step S3), the base station apparatus 2 removes a RB of the lowest reception quality (for example, SINR) or the lowest priority of allocation among the RBs allocated to all the mobile station apparatuses 1 (step S4), and the process returns to step S3. If the number of allocated RBs is not larger than the number of RBs in the system (NO in step S3), the base station apparatus 2 determines the allocation as final allocation. At this time, if the number of RBs to be clipped in the individual mobile station apparatuses 1 is larger than an allowed clipping ratio, the number of RBs before clipping may be reduced.

As described above, in this embodiment, the first number of RBs allocated to all the mobile station apparatuses 1 is adjusted to be smaller than or equal to the number of RBs included in the system band, that is, when frequency allocation is determined, control is performed to suppress variations of an interference level caused by a large first number of RBs, which is the number of RBs before clipping, so that the system is stabilized.

### Second Embodiment

In the second embodiment, unlike in the first embodiment in which the second number of RBs is reduced, a control value for transmit power control is changed to control the amount of interference. For example, in the LTE system, the transmit power of each mobile station apparatus 1 in uplink is defined by expression (2).

$$\begin{matrix}[ Math . 2 ] & \\ {P}_{PUSCH} ( i ) = min \{ {P}_{CMAX} , 10 {log}_{10} ( {M}_{PUSCH} ( i ) ) + {P}_{O\_PUSCH} ( j ) + α ( j ) \cdot PL + {Δ}_{TF} ( i ) + f ( i ) \} & ( 2 )\end{matrix}$$

In expression (2), P_{PUSCH}(i) represents the transmit power of the mobile station apparatus 1 in the i-th subframe (a unit of transmission in the time domain), P_{CMAX} represents the maximum transmit power of the mobile station apparatus 1, M_{PUSCH}(i) represents the number of RBs allocated in the i-th subframe, and P_{O}_{_{—}}_{PUSCH}(j) represents target receive power per one RB, and represents the sum of a target reception level specific to a cell P_{O}_{_{—}}_{PUSCH}_{_{—}}_{NOMIMNAL}(j) and target receive power specific to a mobile station apparatus P_{O}_{_{—}}_{UE}_{_{—}}_{PUSCH}(j) in a transmission method j. Further, α(j) represents a parameter specific to a cell in the transmission method j and is a real number ranging from 0 to 1, PL represents the path-loss between the base station apparatus 2 and the mobile station apparatus 1, Δ_{TF}(i) represents a parameter determined by the modulation scheme applied in the i-th subframe, and f(i) represents a correction term for closed-loop transmit power control notified to the mobile station apparatus 1 in the i-th subframe. That is, expression (2) expresses that the transmit power necessary for achieving the target receive power is set so as not to be higher than the maximum transmit power allowed in the mobile station apparatus 1.

Next, the transmission method j will be described. The transmission method j described here has a number assigned thereto in accordance with the channel used for transmission or a scheduling method. j=0 represents resource allocation for voice call or the like (voice over IP (VoIP)), that is, semi-persistent scheduling (SPS) in which scheduling independent of a channel condition is performed, j=1 represents dynamic scheduling in which scheduling is performed in accordance with a channel condition, mainly used in packet data communication, and j=2 represents a random access channel (RACH) that is transmitted for a change in timing of signal transmission from the mobile station apparatus 1 or synchronization of a signal in uplink, particularly, a RACH (involving an operation called Contention based Random Access Procedure) that is transmitted in a case where collision with a RACH of another mobile station apparatus 1 may occur, such as at the time of initial connection. α(j) is defined as expression (3).

$$\begin{matrix}[ Math . 3 ] & \\ α ( j ) = \{ \begin{matrix}\{ 0 , 0.4 , 0.5 , 0.6 , 0.7 , 0.8 , 0.9 , 1.0 \} & j = 0 , 1 \\ 1 & j = 2\end{matrix} & ( 3 )\end{matrix}$$

This is a parameter that is set to increase the receive power level as the distance from the base station apparatus 2 decreases. For example, in a case where α(j)=1, it means that a path-loss is completely compensated for (attenuation caused by a transmission distance or shadowing is compensated for by increasing transmit power). Transmit power control has an influence on IoT of an adjacent cell. Thus, even if the number of RBs after clipping allocated to all the mobile station apparatuses 1 is larger than the number of RBs included in the system band, setting the target receive power of transmit power control to be low enables clipping to be applied without increasing an interference level for an adjacent cell. Thus, in this embodiment, a description will be given of a method for setting the value of P_{O}_{_{—}}_{PUSCH} in accordance with the first number of RBs.

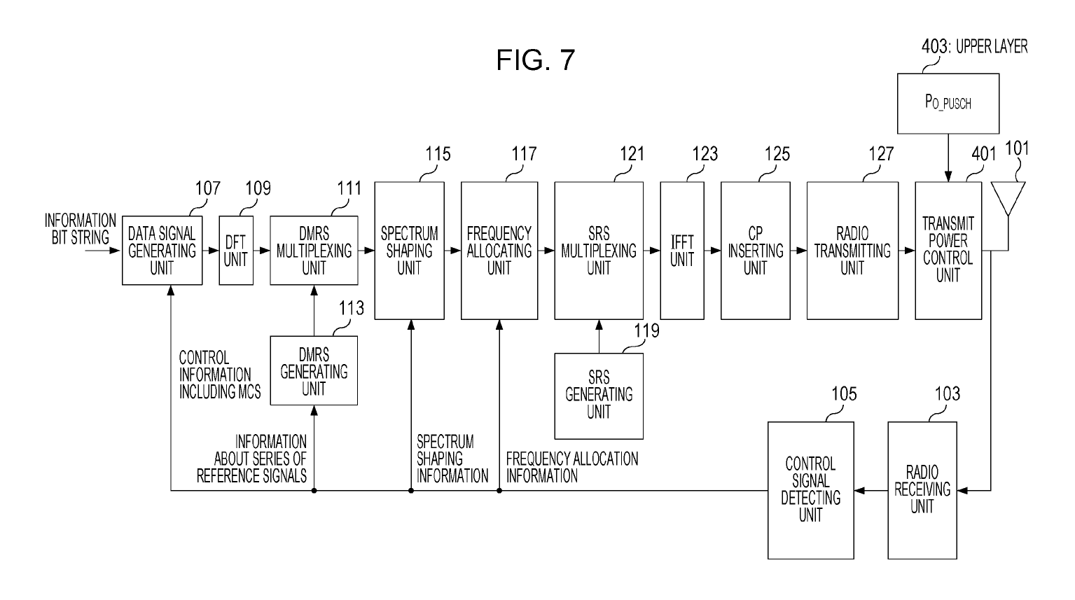

FIG. 7 is a block diagram illustrating the configuration of a mobile station apparatus 1 according to the second embodiment of the present invention. In FIG. 7, the same reference numerals denote the same elements as those in the first embodiment, and thus the description thereof is omitted. FIG. 7 explicitly describes a transmit power control unit 401. In this embodiment, as described above, the value of P_{O}_{_{—}}_{PUSCH} in the target reception level of transmit power is adjusted. The transmit power control unit 401 performs transmit power control so as to obtain transmit power calculated by using expression (2) on the basis of P_{O}_{_{—}}_{PUSCH} notified from an upper layer 403. However, notification of P_{O}_{_{—}}_{PUSCH} may be performed using a control signal in a physical layer, instead of from the upper layer 403. In the present invention, a description is given that P_{O}_{_{—}}_{PUSCH} is controlled. In consideration that transmit power may be eventually adjusted, f(i) in expression (2) may be used instead of P_{O}_{_{—}}_{PUSCH}.

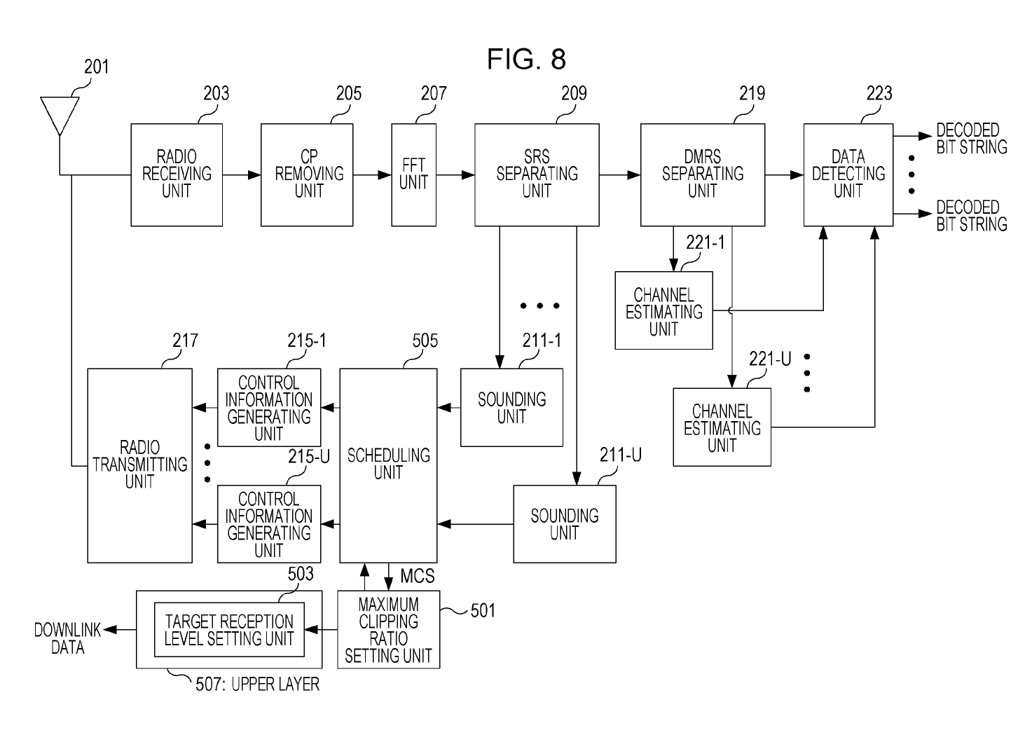

FIG. 8 is a block diagram illustrating the configuration of a base station apparatus 2 according to the second embodiment of the present invention. The configuration illustrated in FIG. 8 is based on the configuration illustrated in FIG. 3, and the same reference numerals denote the same functions or means as those in FIG. 3. A maximum clipping ratio setting unit 501 calculates a maximum clipping ratio. The value of the maximum clipping ratio may be the number of RBs or the ratio with respect to the number of RBs included in the system band. Alternatively, as the value of the maximum clipping ratio, an optimal value or the like obtained through simulation or the like may be set in advance. For example, in a case where the maximum clipping ratio is 20% of the total and where the number of RBs included in the system band is 50, 50/(1−0.2)=62 RBs is regarded as the first number of RBs, and 62 RBs may be allocated to all the mobile station apparatuses 1. The maximum clipping ratio may be a maximum clipping ratio that is allowed for each mobile station apparatus 1. In this case, the total sum of the numbers of RBs that may be clipped in accordance with the maximum clipping ratios of the individual mobile station apparatuses 1 is regarded as the maximum number of RBs that may be clipped. The maximum number of RBs that may be clipped may be defined as a maximum clipping ratio as the ratio of the maximum number of RBs that may be clipped to the first number of RBs.

A target reception level setting unit 503 includes means for setting a target reception level in accordance with the above-described maximum clipping ratio. For example, in the above-described example, in a case where the total sum of the first numbers of RBs is 60, the RBs may be allocated to all the connected mobile station apparatuses 1, and thus the value of transmit power may be reduced to a value 50/60=0.83 times the original value.

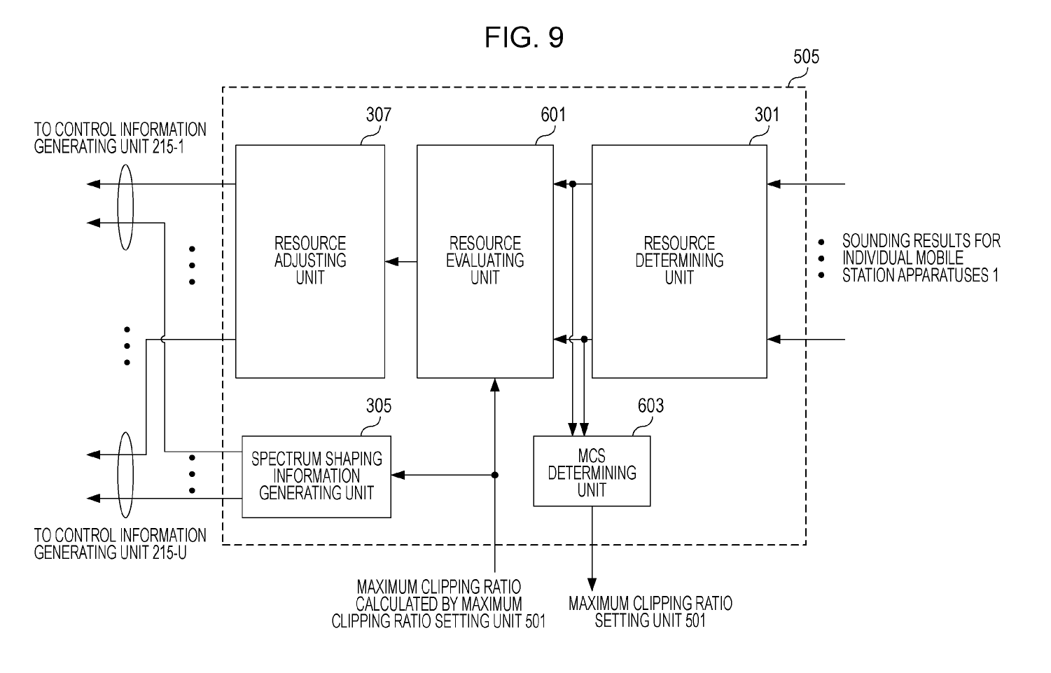

FIG. 9 is a block diagram illustrating the configuration of a scheduling unit 505 according to the second embodiment of the present invention. In the scheduling unit 505, as in FIG. 4, the resource determining unit 301 determines frequency allocation on the basis of sounding results, a resource evaluating unit 601 evaluates whether or not the number of RBs is large on the basis of the frequency allocation and a clipping ratio. If the number of RBs is large, the resource evaluating unit 601 outputs information indicating how large the number is. After that, the resource adjusting unit 307 adjusts the number of RBs and determines the allocation information for the individual mobile station apparatuses 1. On the other hand, an MCS determining unit 603 determines the MCS on the basis of the frequency allocation information determined by the resource determining unit 301. The determined MCS is input to the maximum clipping ratio setting unit 501, where the clipping ratios of the individual mobile station apparatuses 1 are calculated. After that, a maximum clipping ratio that is output is input to the spectrum shaping information generating unit 305. The spectrum shaping information generating unit 305 generates spectrum shaping information for the individual mobile station apparatuses 1.

For example, it is assumed that the number of RBs included in the system band is 10, and that the numbers of RBs allocated to three mobile station apparatuses 1 are (4, 3, 3). In this case, the MCSs calculated from the RBs allocated to the individual mobile station apparatuses 1 are (QPSK (r=⅓), QPSK (r=½), 16QAM (r=½)), respectively. Note that r represents a coding rate. It is assumed that the clipping ratios allowed in the individual MCSs (the ratio of the number of RBs that may be clipped to the first number of RBs) are (50%, 25%, 0%). In this case, the first numbers of RBs calculated from the respective second numbers of RBs are (8, 4, 3), and the total sum is 15. Accordingly, the number of RBs to be clipped in the entire system band is 5, and the maximum clipping ratio is (15-10)/15=0.33=33%. On the basis of this value, transmit power is set by using the following method. In this case, spectrum shaping information represents the first numbers of RBs (8, 4, 3). In the case of further minutely distributing transmit power as in the water filling theorem, such information is also included. In the case of applying this to the first embodiment, allocation of five RBs is released or the number of RBs to be clipped is reduced, on the basis of 33% calculated above.

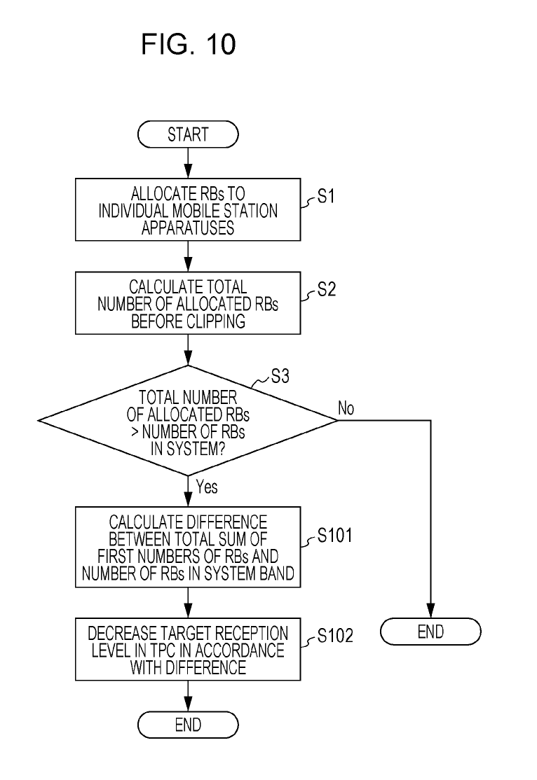

FIG. 10 is a flowchart illustrating the operation of the base station apparatus 2 according to the second embodiment of the present invention. Steps S1 to S3 are the same as those in FIG. 6 according to the first embodiment. In this embodiment, if the total number of RBs is larger than the number of RBs in the system (YES in step S3), the base station apparatus 2 calculates the difference between the total sum of the first numbers of RBs and the number of RBs in the system band (step S101). For example, if the total number of RBs for all the connected mobile station apparatuses 1 is 20 and if the number of RBs included in the system band is 16, the value 20-16=4 is calculated in this case. Subsequently, the base station apparatus 2 sets the target reception level in transmit power control to be lower by the amount corresponding to the calculated number of RBs (step S102). Specifically, in this example, the number of allocated RBs is larger by 4, and thus the transmit power needs to be reduced by the amount corresponding to 4 RBs. That is, the transmit power for 20 RBs is made equal to the transmit power allocated to 16 RBs. In other words, the base station apparatus 2 sets the transmit power for each RB to be reduced to a value 16/20=⅘ times the original value. This may be expressed as follows using decibel: 10×log(⅘)=−0.97 dB. Thus, the base station apparatus 2 sets the target reception level to be reduced by 0.97 dB.

In this way, the base station apparatus 2 determines P_{O}_{_{—}}_{PUSCH} (or f(i)) on the basis of interference to an adjacent cell (IoT estimated in each base station apparatus 2), and thereby a system applying clipping (or spectrum shaping) can be stabilized.

### Third Embodiment

Now, as a third embodiment, a method for controlling both P_{O}_{_{—}}_{PUSCH} and a on the basis of a concept similar to that of the second embodiment will be described.

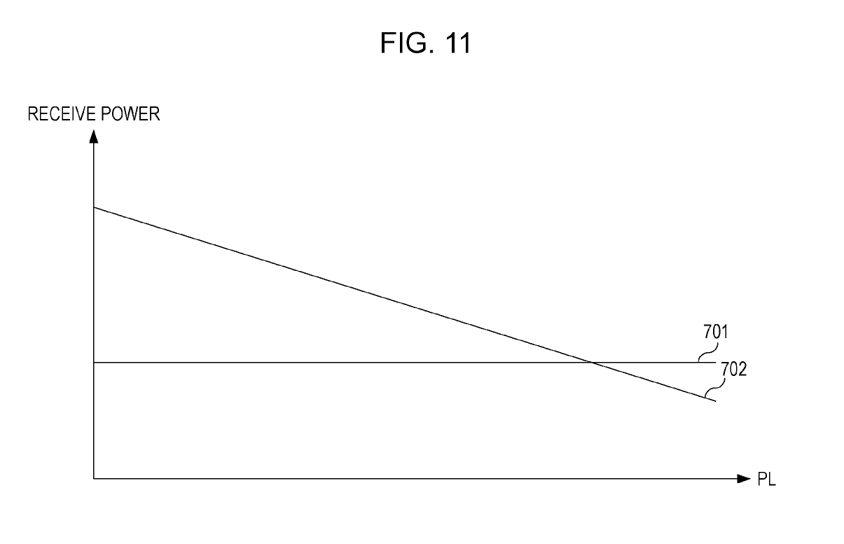

FIG. 11 is a graph illustrating the relationship between the receive power of the base station apparatus 2 and PL in a case where α is changed in the third embodiment of the present invention. In FIG. 11, the horizontal axis represents PL (dB) in expression (2), and the vertical axis represents receive power. A line 701 in a case where α=1 indicates that control is performed to keep constant receive power regardless of the value of PL. A line 702 in a case where α is smaller than 1 indicates that transmit power control is performed so that the receive power increases as the value of PL decreases, that is, as the distance from a base station decreases. Such a method for transmit power control is referred to as fractional transmit power control (FTPC), and has been introduced to recent wireless communication systems, such as the LTE system. Generally, in uplink, a mobile station apparatus 1 farther from a base station is more likely to be a strong interference source to an adjacent cell. Thus, if P_{O}_{_{—}}_{PUSCH} and α are appropriately controlled, the amount of interference to an adjacent cell (IoT measured by the base station apparatus 2 in an adjacent cell) can be kept constant without degrading reception quality of the mobile station apparatus 1 near the base station apparatus 2.

For example, under the assumption of an FDMA (Frequency Division Multiple Access) scheme, in which transmission to the base station apparatus 2 is performed without clipping frequency resources among the mobile station apparatuses 1, in a case where the distance between base station apparatuses is 500 m, P_{O}_{_{—}}_{PUSCH}=−106 dBm, α=1, and an average IoT is about 7 dB, an equivalent IoT can be achieved in a case where P_{O}_{_{—}}_{PUSCH}=−85 dBm and α=0.8. In a case where the maximum clipping ratio is 20%, it is necessary to reduce transmit power by 0.8 dB. In the third embodiment, as a method for realizing an effect equivalent to this, the values of P_{O}_{_{—}}_{PUSCH} and α are controlled.

Specifically, in a case where P_{O}_{_{—}}_{PUSCH}=−76 dBm and α=0.7, the transmit power per one RB is reduced by about 1 dB. The values of P_{O}_{_{—}}_{PUSCH} and α may be determined through a simulation or may be actually measured.

The configuration of the base station apparatus 2 realizing the above is the same as the configuration illustrated in FIG. 8. The target reception level setting unit 503 sets the values of P_{O}_{_{—}}_{PUSCH} and a. Of course, f(i) may be set instead of P_{O}_{_{—}}_{PUSCH} or both of them may be set.

As described above, as a result of applying the present invention, the system is stabilized even if transmit power in the entire cell increases due to clipping.

The first to third embodiments may be applied in combination of one and another. The intrinsically same effect may be obtained by using a method in which at least any one of P_{O}_{_{—}}_{PUSCH} and α is determined first and a maximum clipping ratio or the clipping ratios of individual mobile station apparatuses 1 are set. Further, to control IoT between the base station apparatuses 2, notification may be made as an OI (Overload Indicator) or an HII (High Interface Indicator) by using an X2 interface, which is a wired interface between the base station apparatuses 2. Furthermore, the present invention is applicable to a heterogeneous network in which the radiuses of cells are different, or relaying in which relay stations are installed in picocells, femtocells, or cells, in order to control an interference level.

A program which operates in the mobile station apparatuses 1 and the base station apparatuses 2 according to the present invention is a program (program causing a computer to function) which controls a CPU or the like so as to implement the functions of the above-described embodiments according to the present invention. The information dealt with by these apparatuses is temporarily stored in a RAM at the time of processing thereof, and is then stored in various types of ROM or HDD, and is read out, corrected, or written by the CPU if necessary. A recording medium for storing the program may be any of a semiconductor medium (for example, a ROM, a nonvolatile memory card, etc.), an optical recording medium (for example, a DVD, an MO, an MD, a CD, a BD, etc.), and a magnetic recording medium (for example, a magnetic tape, a flexible disk, etc.). The functions of the above-described embodiments may be implemented through execution of a loaded program, or the functions of the present invention may be implemented through processing which is performed in conjunction with an operating system or another application program or the like in response to an instruction of the program.

In the case of circulating the program on the market, the program may be stored in portable recording media so as to be circulated, or the program may be transferred to a server computer which is connected via a network, such as the Internet. In this case, a storage device of the server computer is included in the present invention. Furthermore, some or all of the mobile station apparatuses 1 and the base station apparatuses 2 according to the above-described embodiments may be implemented by an LSI, which is typically an integrated circuit. The individual functional blocks of the mobile station apparatuses 1 and the base station apparatuses 2 may be individually mounted on chips, or some or all of them may be integrated to be mounted on a chip. A method for integration may be realized by a dedicated circuit or a general-purpose processor, as well as an LSI. In a case where the progress of semiconductor technologies produces an integration technology which replaces an LSI, an integrated circuit according to the technology can be used.

The embodiments of the present invention have been described in detail with reference to the drawings. The specific configurations are not limited to those of the embodiments, and design within a scope of the gist of the present invention is also included in the claims. The present invention may be favorably applied to a mobile communication system in which mobile phone apparatuses serve as the mobile station apparatuses 1, but the present invention is not limited thereto.

### REFERENCE SIGNS LIST

1, 1-1, 1-2 mobile station apparatus
2, 2-1, 2-2 base station apparatus
101 antenna
103 radio receiving unit
105 control signal detecting unit
107 data signal generating unit
109 DFT unit
111 demodulation reference signal multiplexing unit
113 demodulation reference signal generating unit
115 spectrum shaping unit
117 frequency allocating unit
119 sounding reference signal generating unit
121 sounding reference signal multiplexing unit
123 IFFT unit
125 CP inserting unit
127 radio transmitting unit
201 antenna
203 radio receiving unit
205 CP removing unit
207 FFT unit
209 sounding reference signal separating unit
211, 211-1 to 211-U sounding unit
213 scheduling unit
215, 215-1 to 215-U control information generating unit
217 radio transmitting unit
219 demodulation reference signal separating unit
221, 221-1 to 221-U channel estimating unit
223 data detecting unit
301 resource determining unit
303 resource evaluating unit
305 spectrum shaping information generating unit
307 resource adjusting unit
401 transmit power control unit
403 upper layer
501 maximum clipping ratio setting unit
503 target reception level setting unit
505 scheduling unit
601 resource evaluating unit
603 MCS determining unit
701 line in a case where α=1
702 line in a case where α is a value smaller than 1
F1-1, F2-1, O1-1, P2-1 frequency signal

1.-15. (canceled)

16. A wireless control apparatus that performs control in which at least one wireless terminal apparatus clips part of frequencies of a transmit signal allocated in a system band,
wherein the wireless control apparatus determines frequencies at which the individual wireless terminal apparatuses locate transmit signals, so that an interference level of the entire system band is suppressed to be lower than or equal to a certain value.

17. The wireless control apparatus according to claim 16, wherein the wireless control apparatus determines frequencies at which the individual wireless terminal apparatuses locate transmit signals, so that a total sum of frequency bands allocated to the wireless terminal apparatuses before clipping is smaller than or equal to the system band.

18. The wireless control apparatus according to claim 16, wherein the wireless control apparatus calculates a target receive power value in the wireless control apparatus by using a receive power value with which the interference level of the entire system band is lower than or equal to the certain value, a total sum of frequency bands allocated to the wireless terminal apparatuses before clipping, and a clipping ratio of frequencies at which transmit signals are located in the system band, and determines transmit power of the wireless terminal apparatuses on the basis of the target receive power value.

19. The wireless control apparatus according to claim 18, wherein the wireless control apparatus determines transmit power of the wireless terminal apparatuses on the basis of the target receive power value and a parameter specific to a cell controlled by the wireless control apparatus.

20. The wireless control apparatus according to claim 16, wherein, in a case where a total sum of frequency bands allocated to the wireless terminal apparatuses before clipping exceeds the system band, the wireless control apparatus determines transmit power of the wireless terminal apparatuses by subtracting transmit power corresponding to a frequency band as an excess.

21. The wireless control apparatus according to claim 16, wherein the interference level is represented by IoT (Interference over Thermal noise power ratio).

22. The wireless control apparatus according to claim 21, wherein the IoT is determined by a parameter of transmit power control performed by the wireless terminal apparatuses.

23. The wireless control apparatus according to claim 22, wherein the transmit power control is fractional transmit power control.

24. A control program for a wireless control apparatus that performs control in which at least one wireless terminal apparatus clips part of frequencies of a transmit signal allocated in a system band, the control program causing a computer to execute:
a process of determining frequencies at which the individual wireless terminal apparatuses locate transmit signals, so that an interference level of the entire system band is suppressed to be lower than or equal to a certain value.

25. The control program according to claim 24, further comprising:
a process of determining frequencies at which the individual wireless terminal apparatuses locate transmit signals, so that a total sum of frequency bands allocated to the wireless terminal apparatuses before clipping is smaller than or equal to the system band.

26. The control program according to claim 24, further comprising:
a process of calculating a target receive power value in the wireless control apparatus by using a receive power value with which the interference level of the entire system band is lower than or equal to the certain value, a total sum of frequency bands allocated to the wireless terminal apparatuses before clipping, and a clipping ratio of frequencies at which transmit signals are located in the system band; and
a process of determining transmit power of the wireless terminal apparatuses on the basis of the target receive power value.

27. The control program according to claim 26, further comprising:
a process of determining transmit power of the wireless terminal apparatuses on the basis of the target receive power value and a parameter specific to a cell controlled by the wireless control apparatus.

28. The control program according to claim 24, further comprising:
a process of determining, in a case where a total sum of frequency bands allocated to the wireless terminal apparatuses before clipping exceeds the system band, transmit power of the wireless terminal apparatuses by subtracting transmit power corresponding to a frequency band as an excess.

29. An integrated circuit that is mounted in a wireless control apparatus to cause the wireless control apparatus to implement a plurality of functions, the integrated circuit causing the wireless control apparatus to implement a series of functions comprising:
a function of performing control in which at least one wireless terminal apparatus clips part of frequencies of a transmit signal allocated in a system band; and
a function of determining frequencies at which the individual wireless terminal apparatuses locate transmit signals, so that an interference level of the entire system band is suppressed to be lower than or equal to a certain value.
